(19) United States
(12) Patent Application Publication
(10) Pub. No.: US 2015/0234457 A1
(43) Pub. Date: Aug. 20, 2015

(54) SYSTEM AND METHOD FOR CONTENT PROVISION USING GAZE ANALYSIS

(71) Applicant: UMOOVE SERVICES LTD., Geva Binyamin (IL)

(72) Inventor: Yitzchak Kempinski, Geva Binyamin (IL)

(21) Appl. No.: 14/435,745

(22) PCT Filed: Oct. 15, 2013
(86) PCT No.: PCT/IL13/50832

§ 371 Date: Apr. 15, 2015

Related U.S. Application Data
(60) Provisional application No. 61/713,738, filed on Oct. 15, 2012.

(51) Int. Cl. G06F 3/01; G06K 9/00

(52) U.S. Cl. CPC G06F 3/013; G06K 9/00604

(57) ABSTRACT

A system for content provision based on gaze analysis may include a display screen to display a initial content item and a processor to perform gaze analysis on acquired image data of an eye of a viewer viewing the screen to extract a gaze pattern of the viewer with respect to one or a plurality of initial content items, and to cause a presentation of one or a plurality of supplementary content items to the viewer, based on one or a plurality of rules applied on the extracted gaze pattern.

### FIELD OF THE DISCLOSURE

The present disclosure relates to eye-gaze analysis. More specifically the present disclosure relates to system and method for content provision using on gaze analysis.

### BACKGROUND

Eye-gaze analytics (EGA) has become increasingly important in today's society. We live in an era of content explosion. Be it a television, a desktop computer, a laptop, a tablet, a mobile phone or any other device conveying content to viewers through a screen display, screen size may fall short in bringing adequate content to viewers. EGA plays a significant role in assessing interests of an individual viewer. EGA may also play a significant role in assessing interests of viewers in aggregate. This in turn may lead to optimal use of limited display resources used to present content.

Today's state of the art for assessment of viewer interest is manifested through analysis of movement of a hand controlled pointing device, such as a mouse device. Assessment of human interest based on the use of a pointer is based on the assumption that hand movement is correlated to eye gaze location. One problem is that inability to assess viewer preferences and patterns correctly may lead to content clutter, viewer fatigue, loss of interest, poor content relevancy, inefficiencies and deficiencies. In contrast, gaze tracking analytics presents unparalleled opportunity to assess viewer preferences and patterns with greater accuracy.

### SUMMARY

There is provided, in accordance with some embodiments of the present invention, a system for content provision based on gaze analysis. The system may include a display screen to display a initial content item. The system may also include a processor to perform gaze analysis on acquired image data of an eye of a viewer viewing the screen to extract a gaze pattern of the viewer with respect to one or more content items, and to cause a presentation of one or more of supplementary or additional content items to the viewer, based on one or a plurality of rules applied to the extracted gaze pattern.

In some embodiments of the present invention the system may be configured to display one or more initial content items with other content items on the screen.

In some embodiments the processor may be configured to cause the one or more content items to be displayed on the screen.

According to some embodiments of the present invention, the processor may be configured to cause the one or more additional or supplementary content items to be displayed on the screen, replacing a first or a plurality of initial content items.

In some embodiments the processor may be configured to cause said one or a plurality of supplementary content items to be displayed on the screen, with said one or a plurality of initial content items remaining displayed.

In some embodiments said one or a plurality of supplementary content items may include a commercial offer associated with said one or a plurality of initial content items.

According to some embodiments the processor is configured to cause said one or a plurality of supplementary content items to be provided via another device.

In some embodiments the other device is selected from the group of devices consisting of a printer, a mobile communication device, a computing device, and another display device.

In some embodiments the system may further include an imaging sensor to acquire the image data.

In some embodiments the system may further include an illumination source to illuminate the eye of the viewer.

According to some embodiments the gaze pattern relates to one or a plurality of gaze characteristics selected from the group consisting of duration of gaze directed at said one or a plurality of initial content items, number of times the gaze was directed at said one or a plurality of of initial content items, number of times the gaze was directed at said one or a plurality of initial content items over a specific time duration, saccadic movement of the gaze with respect to said one or a plurality of initial content items, combination of gaze directed at different content items of said one or a plurality of initial content items, gaze direction change triggered by said one or a plurality of initial content items, period or periods of time during which the gaze was directed away from any of said one or a plurality of initial content items between consequent gazes directed at that content item or another content item of said one or a plurality of initial content items, changes in time periods during which the gaze was directed away from any of said one or a plurality of initial content items between consequent gazes on that content item, a frequency of which the gaze was directed to any of said one or a plurality of initial content items, time duration of visual feedback at said one or a plurality of initial content items, repetition of visual feedback at said one or a plurality of initial content items, percentage of gaze directed to said one or a plurality of initial content items, speed of directing the gaze away from any of said one or a plurality of initial content items onto a newly presented content, speed of visual feedback migration onto any of said one or a plurality of supplementary content items, and gaze movement within the display area of any of said one or a plurality of initial content items.

There is also provided according to some embodiments of the present invention, a method for content provision based on gaze analysis. The method may include performing, using a processor, gaze analysis on acquired image data of an eye of a viewer viewing a screen on which one or a plurality of initial content items is displayed to extract a gaze pattern of the viewer with respect to the initial content item.

The method may also include causing one or a plurality of supplementary content items to be presented to the viewer, based on one or a plurality of rules applied on the extracted gaze pattern.

There is further provided, in accordance with some embodiments of the present invention a non-transitory computer readable storage medium having stored thereon instructions that when executed by a processor will cause the processor to perform gaze analysis on acquired image data of an eye of a viewer viewing a screen on which one or a plurality of initial content items is displayed to extract a gaze pattern of the viewer with respect to said one or a plurality of initial content item; and cause one or a plurality of supplementary content items to be presented to the viewer, based on one or a plurality of rules applied on the extracted gaze pattern.

### BRIEF DESCRIPTION OF THE DRAWINGS

FIG. 1 illustrates a display device for content provision using gaze analysis, according to an embodiment of the present invention.

FIG. 2A illustrates a display device for content provision using gaze analysis, according to an embodiment of the present invention, viewed by a user, with initial content items presented on the screen.

FIG. 2B illustrates a display device for content provision based on or using gaze analysis, according to an embodiment of the present invention, viewed by a user, with supplementary content items presented on the screen.

FIG. 3 illustrates a method of content provision based on gaze analysis, according to some embodiments of the present invention.

FIG. 4 is a gaze vector diagram presenting a path of a gaze direction of a viewer over a screen of a display device presenting a plurality of content items, in accordance with some embodiments of the present invention.

FIG. 5 illustrates a system 500 for content provision based on gaze analysis, according to some embodiments.

### DETAILED DESCRIPTION

In the following detailed description, numerous specific details are set forth in order to provide a thorough understanding of the methods and systems. However, it will be understood by those skilled in the art that the present methods and systems may be practiced without these specific details. In other instances, well-known methods, procedures, and components have not been described in detail so as not to obscure the present methods and systems.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

We live in an era of content explosion. Be it a television, a desktop computer, a laptop, a tablet, a mobile phone or any other device conveying content to viewers through a screen display, screen size may fall short in bringing adequate content to viewers. A viewer interest in adequate content generally refers to a scenario in which an end-user focuses on content located in a certain area of a display screen or at time, on physical elements surrounding, adjacent or linked to the physical device that contains the display screen. Such screens may be present on for example heads up display, display glasses, mobile phones or other electronic devices. A viewer interest may also be inferred by a move or the speed of move of focus to or away from an area of content or repeatedly returning focus to content. Individual viewer interest or interest of viewers in aggregate may be deduced if viewer refocuses on content that is located on different areas on screen at different times. Interest may be deduced if refocusing on certain content or content category happens even if time had lapsed between content occurrences.

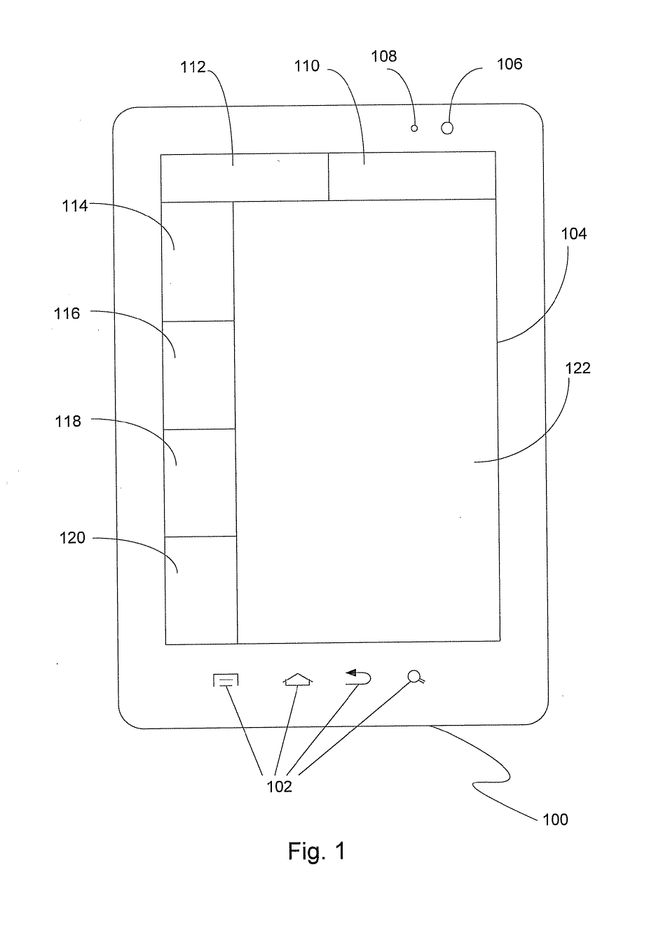

FIG. 1 illustrates a display device 100 for content provision based on gaze analysis, according to an embodiment of the present invention.

Display device 100 is designed or configured to provide a user with information displayed on the device's screen 104 and includes an imaging sensor (e.g., camera 106) for acquiring image data of a face of user viewing the screen (hereinafter—“user” or “viewer”), and in particular image data of one or both eyes of the viewer. In some embodiments of the present invention an illumination source 108 may be provided, to illuminate the face of the user viewing the screen, e.g., in low-light scenarios for clearer view of the camera or for assisting auto-focus of the camera on the viewer's face. The display device 100 may also include one or a plurality of input devices, such as, for example, operation keys or touch surfaces 102, for allowing the user to input commands or information.

According to some embodiments of the present invention, device 100 may be portable or stationary. Device 100 may be, for example, a hand-held display device, such as a portable communication device, cellular phone, smartphone, a tablet (e.g., Apple™ iPad™, Samsung™ Galaxy Tab™), Personal Digital Assistant (PDA). Some embodiments of the present invention may involve a using commercially available device, such as Apple™ iPhone™, Samsung™ Galaxy™, Nokia™ Lumina™, etc. The display device, according to some embodiments of the present invention, may be operated by an operating system such as, for example, iOS™ Android™, Windows™, etc.) and a program or application which is installed on the device and operates it in a manner or manners according to some embodiments of the present invention (see, for example, a description of such manners, hereinafter). Other embodiments of the present invention may include any of various display devices such as, for example, TV sets, computer monitors, advertisement boards, etc., including a built-in front facing imaging sensor (e.g., camera), or connected to an external complementary imaging sensor facing a viewer viewing display content on the display device. The displayed content displayed on the device's screen 104 may include a plurality of initial content items, such as, for example, text item 122, commercial banners 110 and 112, and commercial teasers 114, 116, 118 and 120. By “initial” is meant that these content items are presented any time before one or a plurality of “supplementary” content items (see further below) is presented.

The display device 100 further includes, or is otherwise connected to a processing unit, which runs a program (facilitated by hardware, software of both), implementing a method for content provision based on gaze analysis, in accordance with some embodiments of the present invention. Device 100 may include or be associated with ne or more memory which may store for example a record(s) of a gaze of one or more viewers, one or more patterns of a gaze of one or more viewers, a rule or triggers of gaze parameters, one or more content items and an association of a content items, rules and other content items that may be displayed upon a satisfaction of one or more gaze rules or parameters. For example, a rule may dictate that a repeated series of gazes of for example 3 second each or some other parameter, at a first content item displayed on a screen may satisfy a trigger to display a second content item that may be associated with the content item and the triggered rule. In some embodiments, a memory may store a gaze record or history of one or more users, such as a first gaze record for a first user and a second gaze record for a second user.

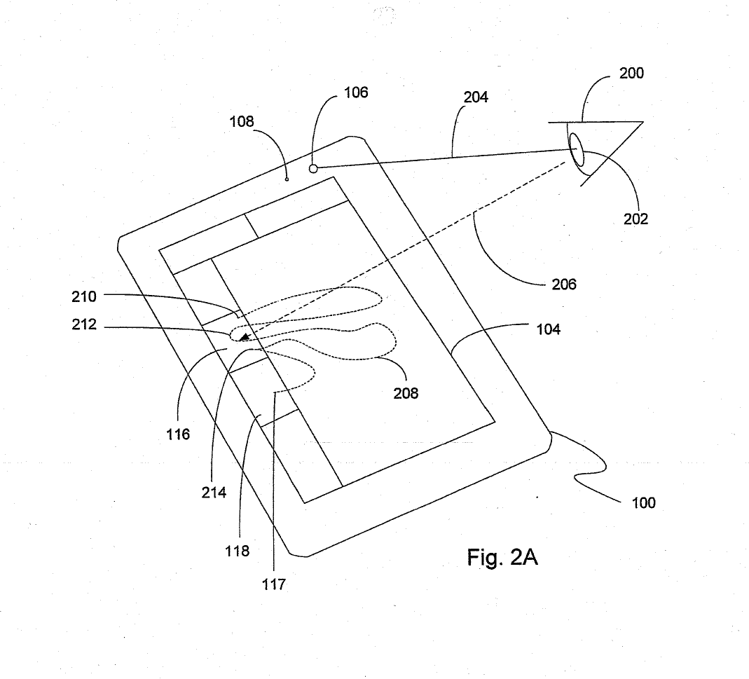

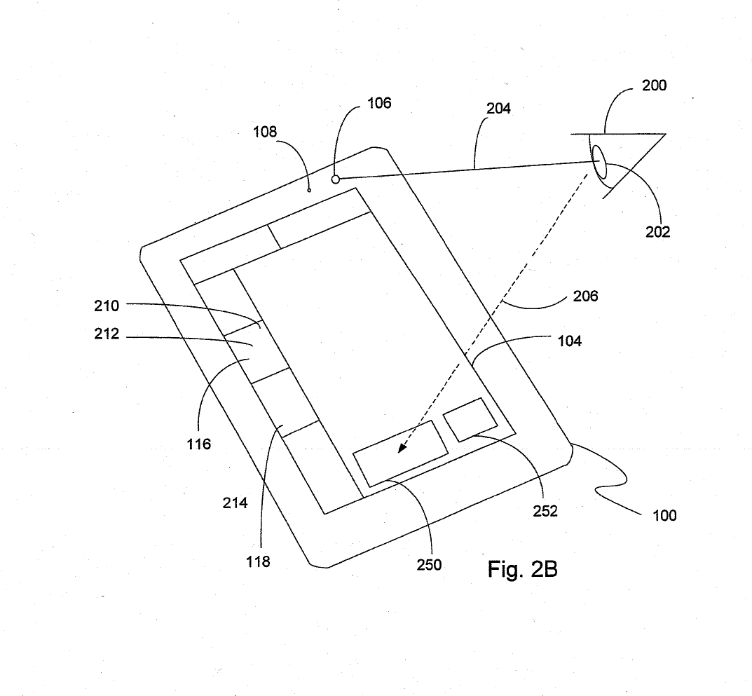

FIG. 2A illustrates a display device 100 for content provision based on gaze analysis, according to an embodiment of the present invention, viewed by a user, with initial content items presented on the screen. In the example shown in this figure, the attention of the viewer (represented in the figure by eye 200) is drawn to commercial teaser 116 on screen 104 which may present, for example, information (e.g., graphics or text or both) relating to a commercially available product which is promoted. The direction of the viewer's eye 200 gaze is indicated in the figure by dashed arrow 206.

According to some embodiments of the present invention, imaging sensor 106 is used to acquire image data of the viewer's eye 200 including pupil 202, and the direction of the viewer's gaze with respect to the presented content on screen 104 may be determined by applying an analysis of the image data. One or more of the content gaze parameters, such as duration, frequency, repeated, saccadic movement at time of gaze, may be stored and associated with the user and/or with the content item viewed by the user.

There are various known techniques for tracking eye gaze, any of which may be incorporated in embodiments of the present invention. For example, such techniques are used to allow persons unable to use their limbs (e.g., paralyzed persons, persons affected by muscular degeneration diseases, such as ALS, etc.) to operate a computing device, by staring at specific icons appearing on the screen of the device (e.g., operation icons, which are normally clicked or otherwise activated by a pointing device). For example, the imaging sensor (e.g., camera) acquires instantaneous image data (e.g., video steam, or stills) of the viewer's eye and an algorithm run by a processor may determine the instantaneous direction of the viewer's gaze with respect to the content shown on the screen. This may be implemented, for example, by analysing the image data of the eye, and determining the position of the pupil of the eye with respect to the viewed eye. Some other embodiments may include determining the position of the darkest point within the pupil of the eye relative to the tracked eye. Various embodiments of the present invention may incorporate any of various gaze tracking devices, determining gaze direction by implementing any suitable gaze analysis techniques. In some embodiments of the present invention the viewer's eye may be illuminated by an illumination source (e.g., illumination source 108), and a reflection of the illuminated eye be acquired by the imaging sensor 106 and analysed by a processing unit associated with the display device.

For example, display device 100 may determine that the viewer has directed her or his gaze to content item 116. Content item 116 may include, for example, graphic or text information (or both) relating to a specific commercially available product or service.

The user's gaze direction 206 may change with respect to content item 116. Curve 208 illustrates the path followed by the user's gaze, starting from a first instance 210 when the user's gaze was directed onto content item 116, the user's gaze then followed path 206 to return again to content item 116 at a second instance 212, wandered off again and returned for the third time to content item 116 at a third instance 214. Further, the user's gaze direction may also wander to another content item 118 at another instance 117.

A display device according to some embodiments of the present invention is configured to acquire eye image data of a viewer viewing content on a screen of the display device, and analyse gaze of the viewed to extract a gaze pattern based on one or a plurality of gaze characteristics with respect to one or a plurality of initial content items displayed by the display device on a screen.

Gaze characteristics may include, for example, duration of gaze directed at said one or a plurality of initial content items, number of times the gaze was directed at said one or a plurality of of initial content items, number of times the gaze was directed at said one or a plurality of initial content items over a specific time duration, saccadic movement of the gaze with respect to said one or a plurality of initial content items, combination of gaze directed at different content items of said one or a plurality of initial content items, gaze direction change triggered by said one or a plurality of initial content items, time period or time periods during which the gaze was directed away from any of said one or a plurality of initial content items between consequent gazes directed at that content item or another content item of said one or a plurality of initial content items, changes in time periods during which the gaze was directed away from any of said one or a plurality of initial content items between consequent gazes on that content item, a frequency of which the gaze was directed to any of said one or a plurality of initial content items, time duration of visual feedback at said one or a plurality of initial content items, repetition of visual feedback at said one or a plurality of initial content items, percentage of gaze directed to said one or a plurality of initial content items, speed of directing the gaze away from any of said one or a plurality of initial content items onto a newly presented content, speed of visual feedback migration onto any of said one or a plurality of supplementary content items, and gaze movement within the display area of any of said one or a plurality of initial content items.

According to some embodiments of the present invention, based on the extracted gaze characteristics, a gaze pattern may be determined, and one or a plurality of rules may be applied on the extracted gaze pattern. Based on said one or more rules one or a plurality of supplementary content items may be presented to the viewer.

Such rule or rules may include, for example relation to one or a plurality of thresholds, ranges, etc., for example, one rule may dictate that if the viewer's gaze is directed more than a predetermined period of time at one or a plurality of the initial content items, one or more supplementary content items will be presented to the viewer. Another rule may dictate that if one or a plurality of initial content items is gazed upon a number of times (e.g., 2 or more), one or more supplementary content items will be presented to the viewer. Yet another example for a rule may dictate that if one or a plurality of initial content items is gazed upon a number of times (e.g., 2 or more) over a certain period of time, one or more supplementary content items will be presented to the viewer. Other rules may apply and a combination or rules may also apply.

FIG. 2B illustrates a display device for content provision based on gaze analysis, according to an embodiment of the present invention, viewed by a user, with supplementary content items 250 and 252 presented on the screen.

In some embodiments of the present invention the supplementary content item may replace the initial content item when displayed on the screen of the display device. In some embodiments of the present invention, the supplementary content item may be provided in the form of a commercial offer, associated with the initial content item. “Offer”, in the context of the present specification may relate to any information which is associated with the initial content item. An “offer” may include, for example, information on where a commercial product or service associated with the initial content item may be obtained, or other terms for obtaining (e.g., its price, reductions), a coupon for buying that product or service with or without a price reduction, information on a another product or service, e.g. complementary or otherwise related product or service, or even a non-related product or service, which the advertiser of the initial content item wishes to associate with the initial content item.

In some other embodiments the supplementary content item may be displayed on the screen in addition to the already displayed initial content item, with the initial content item displaying too.

In some embodiments of the present invention, the supplementary content may be provided in various forms and alternatives. For example, the supplementary content item may be presented in a printed form in a printer, sent in the form of a text or graphic message (or both), e.g., SMS to a mobile communication device, an email sent to a computing device, an image, an advertisement, a notification, promotional information or offering, etc., and even causing the supplementary content item to be displayed on another display device.

According to some embodiments of the present invention methods to locate a viewer momentary gaze, moving gaze or focus on a certain area on a screen of the display device (or on physical elements surrounding or contained in the physical display device that contains the screen) by means of eye gaze analysis. In some embodiments of the present invention methods are applied to locate viewer focus on specific content item or items, or gaze tracking across specific content item or items or display areas by measuring eye movements or otherwise track the instantaneous direction of the viewer's gaze.

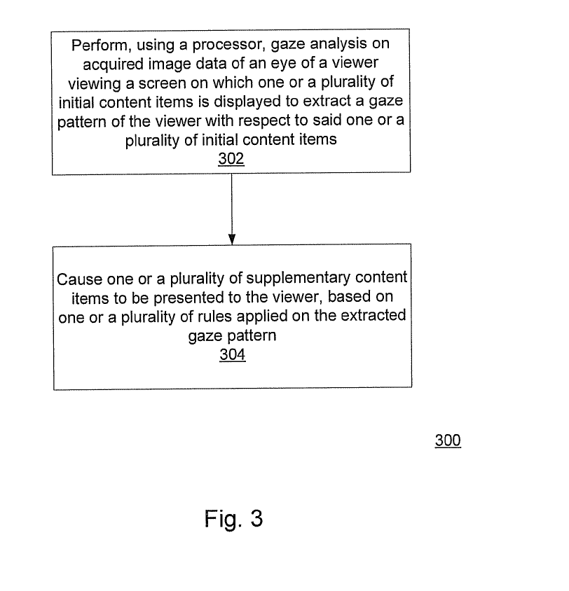

FIG. 3 illustrates a method 300 of content provision based on gaze analysis, according to some embodiments of the present invention.

Method 300 may include performing 302, using a processor, gaze analysis on acquired image data of an eye of a viewer viewing a screen on which one or a plurality of initial content items is displayed to extract a gaze pattern of the viewer with respect to said one or a plurality of initial content items; and causing 304 one or a plurality of supplementary content items to be presented to the viewer based on one or a plurality of rules applied on the extracted gaze pattern.

Method 300 may further include, according to some embodiments of the present invention, displaying the initial content item with other content items on the screen.

Method 300 may further include, according to some embodiments of the present invention, causing the supplementary content item to be displayed on the screen.

Method 300 may further include, according to some embodiments of the present invention, causing the supplementary content item to be displayed on the screen, replacing the initial content item.

Method 300 may further include, according to some embodiments of the present invention, causing the supplementary content item to be displayed on the screen, with the initial content item displaying too.

The supplementary content item may be, in some embodiments, a commercial offer associated with the initial content item.

Method 300 may further include, according to some embodiments of the present invention, causing the supplementary content item to be provided via another device.

The other device may selected, in some embodiments, from the group of devices consisting of a printer, a mobile communication device, a computing device, and another display device.

Method 300 may further include, according to some embodiments of the present invention, using an imaging sensor to acquire the image data.

Method 300 may further include, according to some embodiments of the present invention, using an illumination source to illuminate the eye of the viewer.

The analysis of the image data, according to some embodiments, may include, inter-alia, eye gaze analytics (EGA) information, and visual feedback analytics (VFA) information. Said analytics information may involve, for example, determining one of a plurality of gaze directions, visual feedback pointer location, visual feedback display effect location. In some embodiments EGA information may include time stamp and gaze direction. In some embodiments, VFA information may include time stamp and visual feedback location. In some embodiments, said visual feedback may be correlated to eye gaze at area on display or outside of it. In some embodiments, said visual feedback may be correlated to eye movement where a pointer moves through area on the display screen. In some embodiments, said visual feedback may be correlated to eye blinking occurring during the eye gaze analysis. In some embodiments, said visual feedback may be correlated to lips movement or voice/sound occurring during when a pointer moves through area on the display screen. In some embodiments, said visual feedback may be correlated to head gestures where a pointer moves across an area of the display screen. In some embodiments, said visual feedback may be one or more display effects on area on the display screen. In some embodiments, said display effect may be, but not limited to, one or more area content color change, background color change, brightness change, shape change, animation, content placement, overlayed content, turning off or on of the display or audible cues.

Viewer information may be collected from at least one of, but not limited to, Ad Server, CRM Server, end-user device such as desktop computer, laptop computer, tablet computer, mobile phone, smartphone, input from external sensors or measuring devices, electronic view glasses, etc. and communicated to the display device or to a server cooperating with the display device. The viewer information may include, for example, gender, a viewer location, occupation, interests, favoured activities, hobbies, etc.

In some embodiments of the present invention, eye gaze analytics may include calculating content quality factor or factors. In some embodiments available information about the viewer may be taken into account in calculating the content quality factor. Content quality factor may then be used to assess viewer interest.

In some embodiments, gaze analytics may integrate a viewer gender with gaze duration at the initial content item. In some embodiments, gaze analytics may integrate with said gaze analysis a viewer location and/or other viewer information. In some embodiments, gaze analytics may include ranking high content representing a nearby women hair saloon, based on said gaze analysis and a viewer gender and a viewer location. In some embodiments, gaze analytics may assess viewer interest in content based on changes in gaze analysis characteristics over time. In some embodiments, gaze analytics may assess viewer interest in an advertisement or another media overlay located within a movie. In some embodiments, gaze analytics may assess viewer interest in an advertisement located within an animation. In some embodiments, gaze analytics may assess viewer interest in an advertisement located within an image. In some embodiments, gaze analytics may assess viewer interest in an advertisement located within a full screen display of a plurality of content items. In some embodiments, gaze analytics may assess viewer interest through statistical analysis of at least one gaze analysis characteristic. Some embodiment of the invention may utilize gaze analytics based on data collected for an anonymous viewer. Some embodiments of the invention may utilize gaze analytics based on data collected for a specific viewer. Some embodiments of the invention may utilize gaze analytics based on data collected for a plurality of anonymous viewers. Some embodiments of the invention may utilize gaze analytics based on data collected for a plurality of specific viewers. In some embodiments, a plurality of specific viewers may be related to at least one identifying information item such as gender, physical location, email address, etc.. In some embodiments, content quality factor may be ranked high based on a specific email address, location and same gender adequacy together with high ranking based on visual feedback location statistical analysis over time. Content quality factor may be a multi-dimensional array of quality factors. In some embodiments, a content quality factor may rank adequacy of content for a specific viewer gender. In some embodiments, a content quality factor may rank adequacy of content for a specific viewer age. In some embodiments, a content quality factor may rank adequacy of content for a specific viewer name.

In some embodiments, a content quality factor may rank keywords that represent content. In some embodiments, keywords, such as sport, women apparel, automotive, may correlate with viewer interest.

In some embodiments of the invention content quality factor (CQF) may be made available in real time for at least one recipient of viewer interest assessment (e.g., an Ad Server). In some embodiments, an advertisement (supplementary content item) may be served based on said quality factor in real time to said viewer. In some embodiments, such real time ad placement may be served based on content quality factor directly by integrating ad server functionality or its equivalent into end-user device used by viewer, such as a mobile phone.

In some embodiments, any acquired data, or calculated date (e.g., one or more of gaze characteristics, viewer information, CQF) may be stored on viewer's display device (e.g., smartphone). Raw measurement data may be forwarded to and stored remotely at a device remote from viewer, e.g., on a cloud computing platform. Some embodiments of the invention may involve utilizing data stored locally and/or remotely or stored partly locally and partly remotely for CQF calculation.

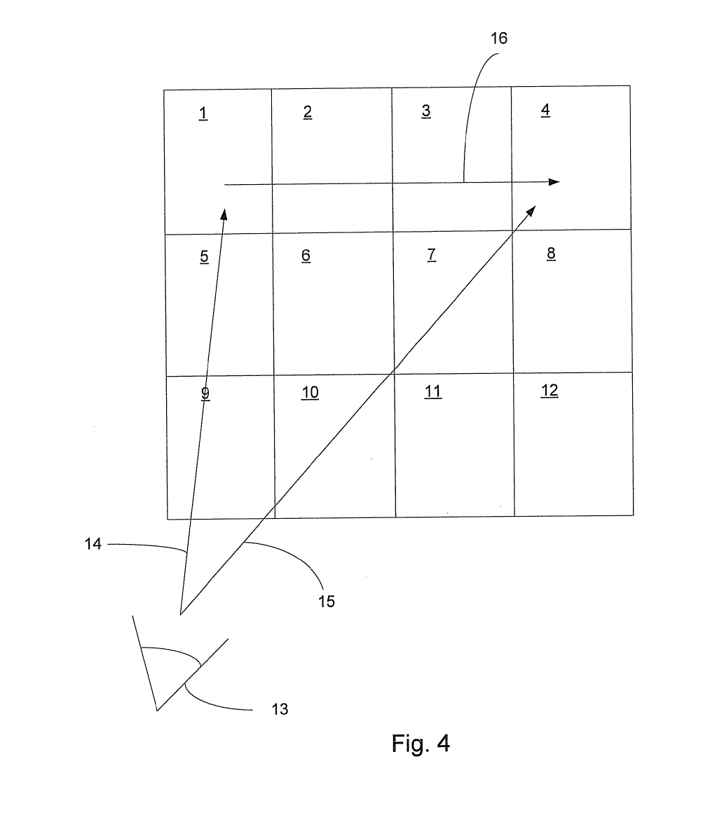

FIG. 4 is a gaze vector diagram presenting a path of a gaze direction of a viewer over a screen of a display device presenting a plurality of content items, in accordance with some embodiments of the present invention.

Display area 1 represents an area of the screen of a display device presenting a content item, and visual feedback area. Similarly, each of display areas 2 through 12 represents a content item, and visual feedback area. Viewer 13 is viewing the screen. Viewer 13 may gaze at display area 1, the gaze direction represented by vector 14. In some embodiments, viewer interest assessment may be calculated based on the time duration of the viewer's gazing at display area 1. In some embodiments, content changes at display area 4. It may take some time to pass between the content change and viewer 13 moving the direction of gaze to display area 4, indicated by vector 15. In some embodiments, Vector 16 may be calculated based on gaze analysis, which represents the time lapse between gaze vector 15 and vector 14 and a distance (e.g., pixel distance) between display area 4 and display area 1. A CQF related to display area 1 and a CQF related to display area 4 may then be calculated based on one or more of CQF related to display area 1.

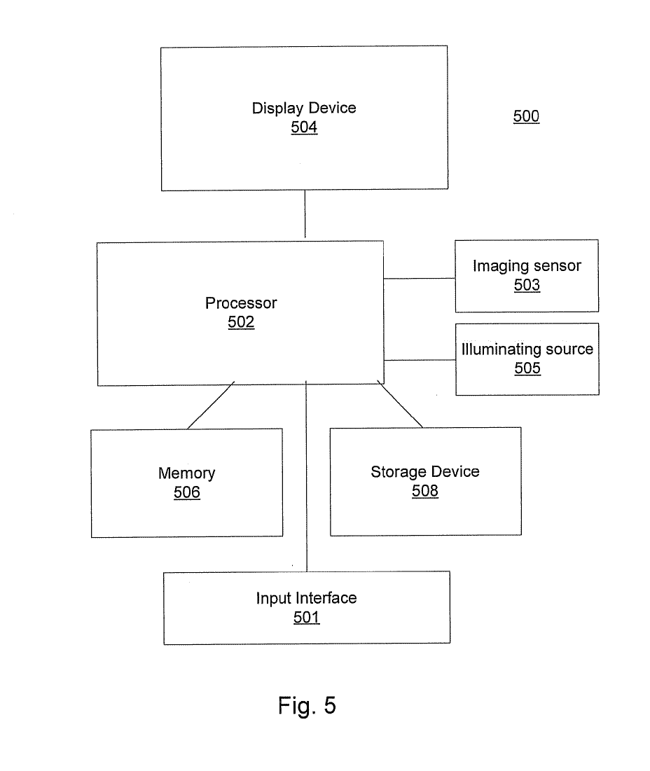

FIG. 5 illustrates a system 500 for content provision based on gaze analysis, according to some embodiments.

System 500 may include a processor 502 (e.g. one or a plurality of processors, on a single machine or distributed on a plurality of machines) for executing a method of content provision based on gaze analysis, according to some embodiments of the present invention. Processor 502 may be linked with memory 506 on which a program implementing a method according to some embodiments and corresponding data may be loaded and run from, and storage device 508, which includes a non-transitory computer readable medium (or mediums) such as, for example, one or a plurality of hard disks, flash memory devices, etc. on which data (e.g. dynamic object information, values of fields, etc.) and a program implementing a method according to some embodiments and corresponding data may be stored. System 500 may further include display device 504 (e.g. CRT, LCD, LED etc.) on which one or a plurality of content items may be presented. System 500 may also include input device 501, such as, for example, one or a plurality of keyboards, pointing devices, touch sensitive surfaces (e.g. touch sensitive screens), etc. for allowing a user to input commands and data.

System 500 may include an imaging sensor 503, for acquiring image date relating to the viewer's gaze, and may also include an illumination source 505, for illuminating the viewer's eye.

Some embodiments may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with examples. In some examples the instructions stores on the computer readable medium may be in the form of an installed application and in the form of an installation package.

Such instructions may be, for example, loaded by one or more processors and get executed.

For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

Some embodiments are described hereinabove with reference to flowcharts and/or block diagrams depicting methods, systems and computer program products according to various embodiments.

In some embodiments, a gaze tracking may record the natural or unintentional eye movements of a user that may occur while the user gazes at an item or display, such as a saccadic movement of an eye. An analysis of such unintentional or autonomous movement may be recorded or analyzed to determine an interest of the user as to the item displayed. A level of interest may be associated with the viewed item, and based on such level of interest, a second or other item may be displayed to the user.

In some embodiments, a item that may be viewed by a user may be a real world item (as opposed to an image of an item displayed on an electronic screen) that appears in a view of a user. The gaze of the user at the real world item may be recorded by a camera at a known position relative to the real world item. A content item on a display may be altered as a result of the collected and analyzed gaze of the user at the real world item. For example, a user may look at dress on a mannequin in a store. A camera at a known position from the mannequin may capture the user's gaze at the dress, and a content item such as a coupon or sale notice may appear on a screen that is in an area of the user, or on the user's portable phone or tablet.

Features of various examples discussed herein may be used with other embodiments discussed herein. The foregoing description of the embodiments has been presented for the purposes of illustration and description. It is not intended to be exhaustive or limiting to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes that fall within the true spirit of the disclosure.

1. A system for content provision based on gaze analysis, the system comprising:
a display screen to display a initial content item;
a processor to perform gaze analysis on acquired image data of an eye of a viewer viewing the screen to extract a gaze pattern of the viewer with respect to one or a plurality of initial content items, and to cause a presentation of one or a plurality of supplementary content items to the viewer, based on one or a plurality of rules applied on the extracted gaze pattern.

2. The system of claim 1, configured to display said one or a plurality of initial content items with other content items on the screen.

3. The system of claim 1, wherein the processor is configured to cause said one or a plurality of supplementary content items to be displayed on the screen.

4. The system of claim 1, wherein the processor is configured to cause said one or a plurality of supplementary content items to be displayed on the screen, replacing said one or a plurality of initial content items.

5. The system of claim 1, wherein the processor is configured to cause said one or a plurality of supplementary content items to be displayed on the screen, with said one or a plurality of initial content items remaining displayed.

6. The system of claim 1, wherein said one or a plurality of supplementary content items comprises a commercial offer associated with said one or a plurality of initial content items.

7. The system of claim 1, wherein the processor is configured to cause said one or a plurality of supplementary content items to be provided via another device.

8. The system of claim 7, wherein the other device is selected from the group of devices consisting of a printer, a mobile communication device, a computing device, and another display device.

9. The system of claim 1, further comprising an imaging sensor to acquire the image data.

10. The system of claim 1, further comprising an illumination source to illuminate the eye of the viewer.

11. The system of claim 1, wherein the gaze pattern relates to one or a plurality of gaze characteristics selected from the group consisting of duration of gaze directed at said one or a plurality of initial content items, number of times the gaze was directed at said one or a plurality of initial content items, number of times the gaze was directed at said one or a plurality of initial content items over a specific time duration, saccadic movement of the gaze with respect to said one or a plurality of initial content items, combination of gaze directed at different content items of said one or a plurality of initial content items, gaze direction change triggered by said one or a plurality of initial content items, period or periods of time during which the gaze was directed away from any of said one or a plurality of initial content items between consequent gazes directed at that content item or another content item of said one or a plurality of initial content items, changes in time periods during which the gaze was directed away from any of said one or a plurality of initial content items between consequent gazes on that content item, a frequency of which the gaze was directed to any of said one or a plurality of initial content items, time duration of visual feedback at said one or a plurality of initial content items, repetition of visual feedback at said one or a plurality of initial content items, percentage of gaze directed to said one or a plurality of initial content items, speed of directing the gaze away from any of said one or a plurality of initial content items onto a newly presented content, speed of visual feedback migration onto any of said one or a plurality of supplementary content items, and gaze movement within the display area of any of said one or a plurality of initial content items.

12. A method for content provision based on gaze analysis, the method comprising:
performing, using a processor, gaze analysis on acquired image data of an eye of a viewer viewing a screen on which one or a plurality of initial content items is displayed to extract a gaze pattern of the viewer with respect to the initial content item; and
causing one or a plurality of supplementary content items to be presented to the viewer, based on one or a plurality of rules applied on the extracted gaze pattern.

13. The method of claim 12, further comprising displaying said one or a plurality of initial content items with other content items on the screen.

14. The method of claim 12, further comprising causing said one or a plurality of supplementary content items to be displayed on the screen.

15. The method of claim 12, further comprising causing said one or a plurality of supplementary content item to be displayed on the screen, replacing said one or a plurality of initial content items.

16. The method of claim 12, further comprising causing said one or a plurality of supplementary content items to be displayed on the screen, with said one or a plurality of initial content items remaining displayed.

17. The method claim 12, wherein said one or a plurality of supplementary content items comprises a commercial offer associated with said one or a plurality of initial content items.

18-21. (canceled)

22. A non-transitory computer readable storage medium having stored thereon instructions that when executed by a processor cause the processor to:
perform gaze analysis on acquired image data of an eye of a viewer viewing a screen on which one or a plurality of initial content items is displayed to extract a gaze pattern of the viewer with respect to said one or a plurality of initial content item; and
cause one or a plurality of supplementary content items to be presented to the viewer, based on one or a plurality of rules applied on the extracted gaze pattern

23. The non-transitory computer readable storage medium of claim 22, wherein the instructions cause the processor to cause said one or a plurality of supplementary content items to be displayed on the screen.

24-26. (canceled)

27. The non-transitory computer readable storage medium of claim 22, wherein the instructions cause the processor to display said one or a plurality of initial content items with other content items on the screen.
